(19) United States
(12) Patent Application Publication
(10) Pub. No.: US 2003/0088346 A1
(43) Pub. Date: May 8, 2003

(54) Noise, vibration and harshness analyzer

(75) Inventors: Thomas R. Calkins, Santa Barbara, CA (US); Philip Wilson, Santa Barbara, CA (US)

Correspondence Address: KOPPEL, JACOBS, PATRICK & HEYBL, 555 ST. CHARLES DRIVE, SUITE 107, THOUSAND OAKS, CA, 91360, US

(73) Assignee: VETRONIX CORPORATION

(21) Appl. No.: 10/280,185

(22) Filed: Oct. 25, 2002

Related U.S. Application Data
(60) Provisional application No. 60/343,798, filed on Oct. 27, 2001.

(51) Int. Cl. G01M 17/00; G06F 7/00

(52) U.S. Cl. 701/29; 73/570; 73/78

(57) ABSTRACT

A vehicle noise, vibration and harshness analysis tool according to the present invention comprises at least one sensor, each sensing a vibration or noise and generating a signal at a frequency related to the vibration or noise. A communication link with a vehicle is included to transmit data regarding the vehicle. A microprocessor system receives the signals generated by said at least one sensor and receives the vehicle data over said communication link. The microprocessor system conducts an analysis of the received sensor signals and vehicle data and identifies a vehicle component that is likely causing a vibration or noise. The microprocessor system also identifies the possible problems with the identified vehicle component. A user interface is also included with a display. The microprocessor system causes the display to list the likely vehicle components causing the vibration or noise and the possible problems with the components. The list of likely components and causes helps the technician quickly isolate and remedy the cause of the vibration or noise. The invention also discloses methods for balancing a driveshaft using analyzers according to the invention.

This application claims the benefit of provisional application Serial Number 60/343,798 to Calkins, which was filed on Dec. 27, 2001, but was erroneously given a filing date of Oct. 27, 2001 by the receiving office of the Patent and Trademark office.

### BACKGROUND OF THE INVENTION

1. Field of the Invention

This invention relates to vehicle testers and more particularly to a hand held noise, vibration and harshness tester for vehicles.

2. Description of the Related Art

Noise, vibration and harshness concerns are one of the top “No Trouble Found” (NTF) anomalies in the dealer and independent service environment. In many instances, a vehicle is brought in with noise and vibration complaints but using conventional means the dealership is unable to diagnose the cause. After an NTF diagnosis, the vehicle is returned to the owner without addressing the problem. The vehicle owner will often return the vehicle for additional service complaining of continued noise, vibration or harshness conditions. These returns for service can lead to customer dissatisfaction and increased dealer service costs.

Various vibration analyzers have been developed for use with operating machinery to help detect machine fault conditions. For example, U.S. Pat. No. 9,965,819 to Piety, discloses a portable data collector and analyzer having multiple paths for performing multiple processing functions. The data collector has a sensor that is placed against a vibrating machine and creates a sensor signal that represents a measured property of an operating machine. The sensor signal is simultaneously sent to at least two processor channels that are connected in parallel, with each processor capable of performing different types of signal processing. The parallel processor channels work independently of each other to obtain results corresponding to a number of different tests. The data collector's parallel paths reduce the amount of time required to perform periodic maintenance surveys.

Vibration analyzers have also been developed to test for vibrations in vehicle drivelines. For example, U.S. Pat. No. 5,955,674, to McGovern, discloses a heavy duty truck diagnostic vibration analyzing tool for measuring and characterizing the torsional vibration—of a transmission output shaft in the truck's driveline. An electronic control unit and speed sensor cooperate to measure speed fluctuations occurring between the passing teeth of a rotating gear. These time measurements are then filtered using an order tracked band pass filter to isolate frequencies of interest. The results are then used to calculate a total torsional energy level, which is compared to a predetermined maximum amplitude. If the total energy exceeds the predetermined maximum, a driver-warning device is triggered.

This tester has limited capabilities in that it only measures speed fluctuations by measuring passing teeth of rotating gears, which can limit its testing to driveline vibration testing. Further, it only alerts the driver of a problem, it does not predict a likely source of the vibration or what may be causing the vibration at its source.

Vetronix Corporation (same assignee as the present application) has developed a vehicle “diagnostic toolset” tester, referred to as the Mastertech NVH Kit, which provides for a range of vehicle diagnostics. One of the elements of the diagnostic toolset is a noise and vibration analyzer that is designed to simplify the time required to isolate the cause of vehicle noise and vibrations. The components making up the analyzer include a diagnostic tester that controls all of the functions of the analyzer and provides the user interface. The analyzer software resides on a program card and processes two types of input data: vehicle serial data (RPM and vehicle speed) from the vehicle's diagnostic connector and vibration or noise data from an accelerometer or optional microphone. The tester computes the frequency spectrum of the sampled data and correlates that spectrum with frequencies associated with various vibration or noise sources as computed from the engine RPM and vehicle speed.

Among the disadvantages of the Vetronix tester is that it requires multiple modules to perform its noise and vibration testing. Another disadvantage is that the tester is only capable of receiving a vibration or noise signal from one sensor, limiting its testing capabilities. Further, the tester does not generate outputs to assist in vibration analysis and is not capable of communicating over an RS232 cable with a personal computer or printer. The tester also has limited display abilities and while it can provide a potential source of the vibration or noise, it cannot predict what the cause of the vibration or noise may be.

### SUMMARY OF THE INVENTION

The present invention seeks to provide an improved Noise, vibration and harshness analyzers (“analyzer”) that is hand held, lightweight, portable and easy to use. It is designed to aid in the quick identification and isolation of noise, vibration and harshness faults in vehicles.

An analyzer according to the present invention comprises at least one sensor, each sensing a vibration or noise and generating a signal at a frequency related to the vibration or noise. A communication link with a vehicle is included to transmit data regarding the vehicle. A microprocessor system receives the signals generated by said at least one sensor and receives the vehicle data over said communication link. The microprocessor system conducts an analysis of the received sensor signals and vehicle data and identifies a vehicle component that is likely causing a vibration or noise. The microprocessor system also identifies the possible problems with the identified vehicle component. A user interface is also included with a display. The microprocessor system causes the display to list the likely vehicle components causing the vibration or noise and the possible problems with the components.

The list of likely components and causes helps the technician quickly isolate and remedy the cause of the vibration or noise. For instance, if the analyzer display shows that the vibration corresponds to a first order wheel condition, the analyzer can than display a list of the probable causes of a first order wheel condition, such as tire or wheel imbalance, wheel hub runout, axle flange runout, or ring gear runout.

The possible causes of a noise, vibration and harshness condition are narrowed down so that they can be remedied in a timely manner. The analyzer achieves this by a unique combination of inputs including vibration sensor data, vehicle serial data, technician input, and a diagnostic database, which, in combination, produce reliable diagnoses in a short amount of time.

The present invention also discloses a method for determining if a driveshaft is balanced, which utilizes an analyzer according to the present invention. A first balance test in performed on an unmodified driveshaft. A second balance test is then performed on the same driveshaft with a test weight mounted to the driveshaft. The results of the first and second balance tests are analyzed to determine if the driveshaft is out of balance.

In a similar test according to the invention uses three tests instead of two. A first balance test in performed on an unmodified driveshaft. The second test is performed with a test weight attached near the front of the driveshaft and a third test is performed with the weight attached near the rear of the driveshaft. The results of the first, second and third tests are analyzed to determine it the driveshaft is balanced.

For both of these methods, the analyzer can also determine the size and location for a weight to be attached to the driveshaft to counter any driveshaft imbalance. The weight can be attached and the driveshaft can tested again to confirm that it is balanced.

These and other further features and advantages of the invention would be apparent to those skilled in the art from the following detailed description, taking together with the accompanying drawings, in which:

### BRIEF DESCRIPTION OF THE DRAWINGS

FIG. 1 is a perspective view of an analyzer according to the present invention;

FIG. 2 is a block diagram of the an analyzer according to the present invention with interconnects to its attached devices and a vehicle;

FIG. 3 is a block diagram of the circuitry of analyzer according to the present invention;

FIG. 4 is a block diagram of the microprocessor subsystem circuitry in the analyzer of FIG. 3;

FIG. 5 is a block diagram of the instrumentation subsystem circuitry in the analyzer of FIG. 3;

FIG. 6 is a block diagram of the vehicle interface subsystem circuitry in the analyzer of FIG. 3;

FIG. 7 is a block diagram of the user interface subsystem circuitry in the analyzer of FIG. 3;

FIG. 8 is a block diagram of the power subsystem circuitry in the analyzer of FIG. 3;

FIG. 9 is a frequency spectrum display for an analyzer according to the present invention;

FIG. 10 is a bar chart display for an analyzer according to the present invention;

FIG. 11 is a waterfall display for an analyzer according to the present invention;

FIG. 12 is a principal component display for an analyzer according to the present invention;

FIG. 13 is a block diagram of a single-plane driveshaft balancing system according to the present invention; and

FIG. 14 is a block diagram of a dual-plane driveshaft balancing system according to the present invention.

### DETAILED DESCRIPTION OF THE INVENTION

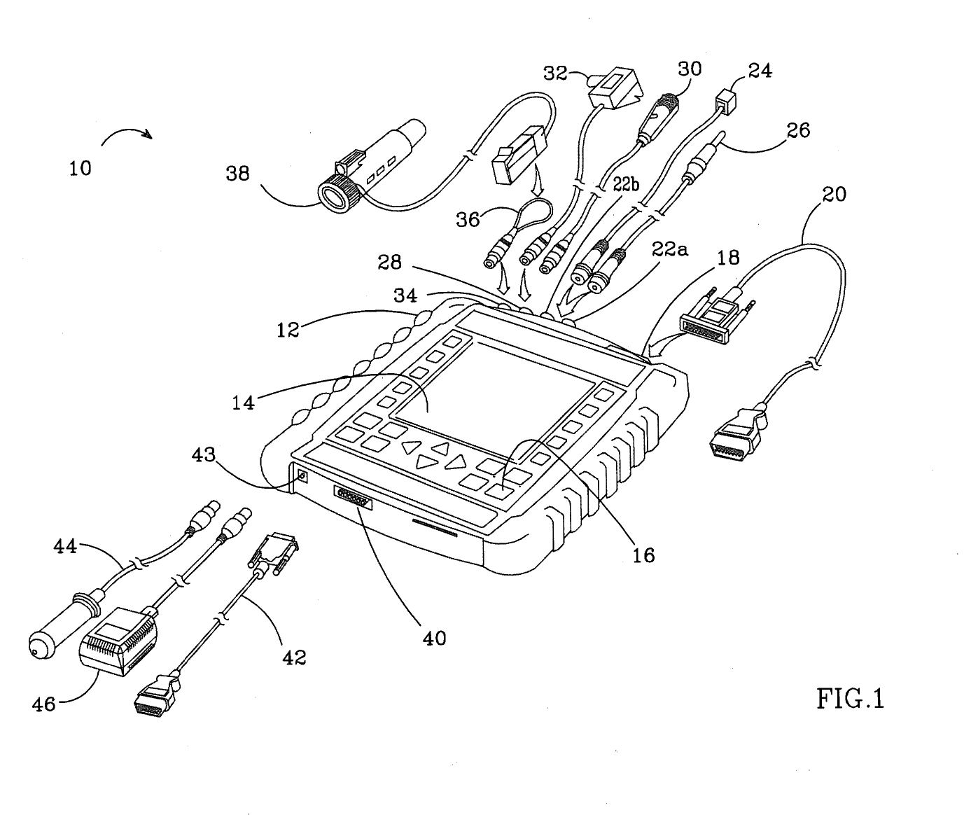

FIG. 1 shows a perspective view of an analyzer 10 in accordance with the present invention with some of its peripheral components, which together function as a lightweight, high powered and portable noise/vibration analysis tool. The analyzer 10 is housed in a rugged plastic enclosure 12 that has a quarter-VGA LCD display 14 and a keypad 16 having keys disposed on the enclosure 12 around the bottom and sides of the LCD Display 14. Many different keypads can be used with a preferred keypad having a hydrocarbon resistant membrane and 22 keys including 10 numeric keys, 4 cursor control keys, a HELP key, and a modifier key, (SHIFT) and miscellaneous 25 keys.

The top surface of the analyzer 10 has five connectors, although other embodiments of the invention can have more or fewer connectors. An on board diagnostics level II (OBD II) connector 18 is included to 30 connect to an OBD II cable 20 to provide a communication link to a the J1962 data link connector (DLC) in OBD II compliant vehicles. Two input connectors 22a, 22b are included, each of which connects to a sensor. The sensor connectors 22a,22b are preferably connected to any combination of two accelerometers 24 or two microphones 26, or one accelerometer 24 and/or one microphone 26. A connector 28 provides power to and receives a signal from a device connected to it, such as a remote trigger switch 30 or a photo tachometer 32. The photo-tachometer 32 is described in more detail below. The remote trigger switch 30 allows pause and save functions of the analyzer 10 to be performed by a single actuation of the remote trigger. This allows the analyzer to be used for safe, single operator, road testing. An output connector 34 provides a signal to an inductive loop 36, which is attached to a timing light 38 to control the flashing of the timing light.

The bottom surface of the analyzer 10 includes two connectors, although other embodiments can more or fewer connectors. The first bottom connector 40 is an industry standard bi-directional RS232 communication port, which allows an RS232 cable 42 to be connected to the analyzer 10. This allows the analyzer 10 to communicate with PC-based systems for download and analysis of data, and to interface with other RS232 compatible devices such as printers and display terminals. The analyzer's software can also be updated in the field via RS232 download from a PC.

The second bottom connector 43 is a DC power connector that serves as a connection to a DC power cable that powers the analyzer 10. A DC power connector and cable 44 can be connected to a standard vehicle cigarette lighter to provide DC power to the analyzer 10. Alternatively, an AC/DC adapter and cable 46 can be plugged into a standard AC wall power socket to provide to convert standard AC power to DC power for the analyzer.

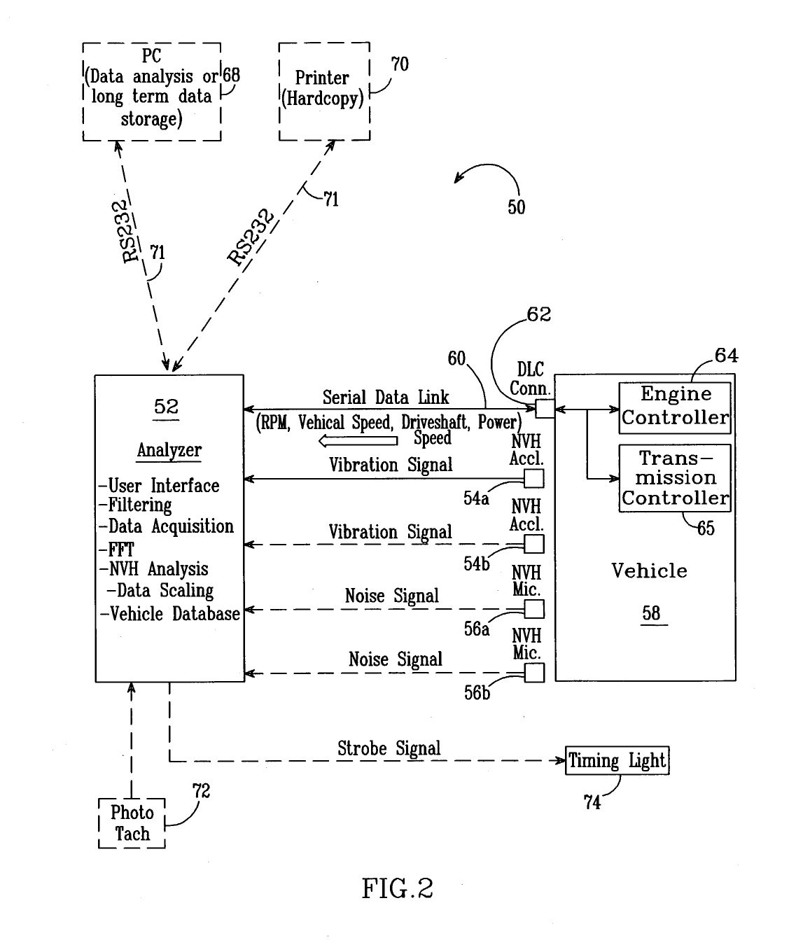

FIG. 2 is an interface block diagram 50 showing some of the different devices that can be connected to an analyzer 52 according to the present invention. As described above, two input connectors allow different combinations of two accelerometers 54a and 54b or two microphones 56a and 56b to be connected to the analyzer 52. The accelerometers 54a, 54b and/or microphones 56a, 56b can be mounted on a vehicle 58 or directed toward the vehicle to sense the vibration or noise frequency generated by various vehicle components.

A serial data link is also established between the vehicle 58 and the analyzer 52 over an OBD II cable 60, which is connected between the analyzer 52 as described above, and is connected to the vehicle 58 at its (DLC) connector 62. Data from the vehicle's engine controller 64 and transmission controller 65 are transmitted to the analyzer 52 over the cable 60. This data can include different information such as vehicle speed, engine revolutions per minute (RPM) and/or transmission RPM and the cable can also provide power from the vehicle 58 to the analyzer 52.

With OBD II compliant vehicles, the analyzer 52 can dynamically synchronize serial data coming across the DLC connector with the vibration input being measured by the accelerometers 54a, 54b or noise input from the microphones 56a, 56b, in different combinations. This allows a user to view vibration or noise characteristics at various speeds, or during acceleration or deceleration. With non-OBD II complaint vehicles, the user inputs the vehicle speed and RPM into the analyzer 52 using the keyboard.

The analyzer 52 can also communicate with RS232 devices such as a personal computer (PC) 68 or a printer 70 over an RS232 cable 71. The analyzer 52 also provides outputs for a photo tachometer 72 and a strobe light 74.

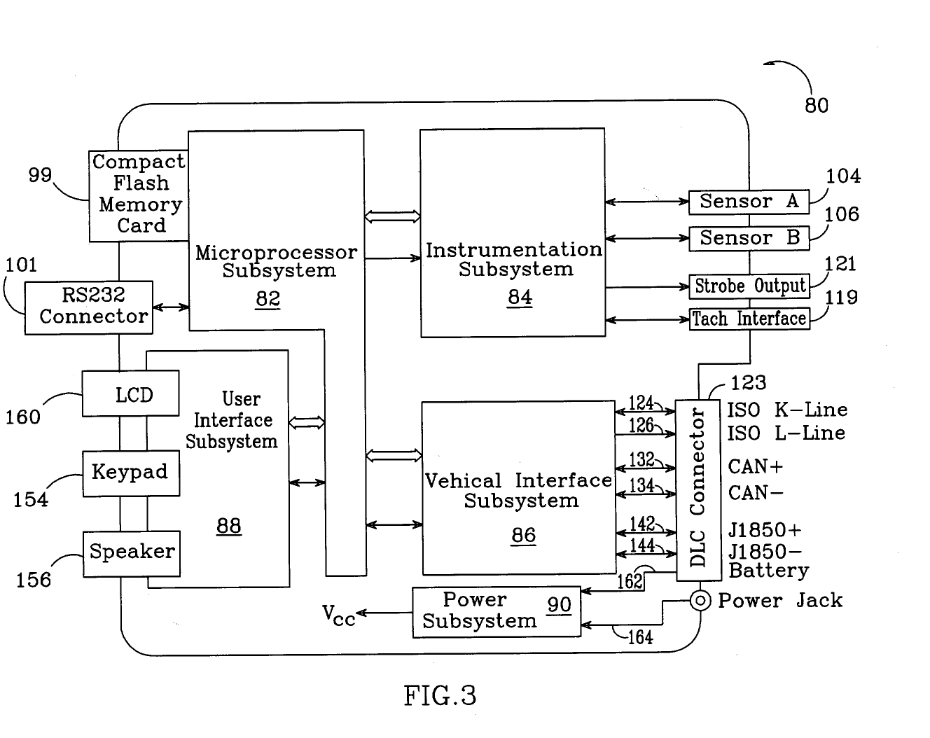

FIG. 3 is a block diagram of the circuitry of an analyzer 80 according to the present invention, which can be generally divided into five subsystems which include the microprocessor subsystem 82, instrumentation subsystem 84, vehicle interface subsystem 86, user interface subsystem 88, and power subsystem 90. Each of these subsystems is described below with reference to FIG. 3 and FIGS. 4-8.

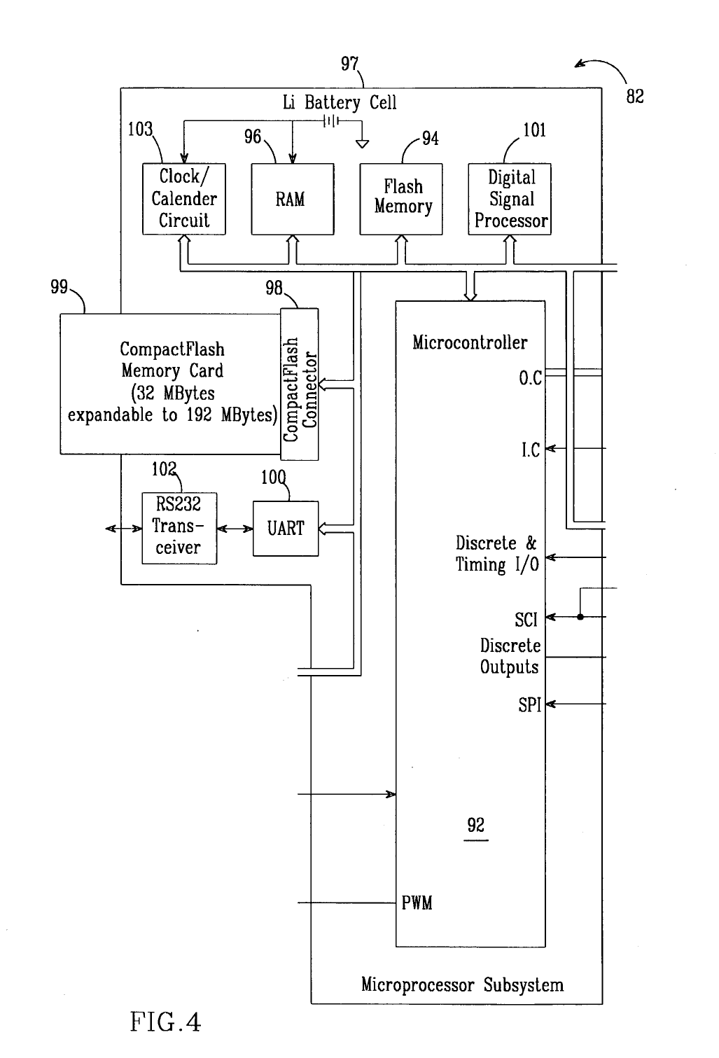

FIG. 4 shows a more detailed block diagram of the microprocessor subsystem 82, which is the controlling component of the analyzer 80, and centers on a microcontroller 92. Many different microcontrollers can be used, with a preferred microcontroller 92 being a Motorola MC68331, which has a powerful 32-bit CPU32 core operating at 25 MHz and a complement of I/0 devices integrated on chip, including serial communication and timing I/O.

The microprocessor subsystem 82 also contains eight megabytes of flash electrically erasable programmable read only memory (EEPROM) 94 and one megabyte of static random access memory (RAM) 96, although different types and different sizes of memory can also be used. The flash EEPROM 94 is segmented memory with one of the segments functioning as hardware protected “boot” segment. The boot segment contains all software necessary to communicate with a host computer (via RS232) and download application software to the other flash segments. This allows the analyzer 80 to be fully field reprogrammable. In addition to providing storage for the application software, the flash EEPROM 94 provides non-volatile storage for data that is collected during testing. This data can then be reviewed after the test, or uploaded to a PC for long-term storage.

A thirty-two (32) megabyte CompactFlash memory device 99 is included which can store data under control of the microcontroller 92. This memory device is removable and plugs into the CompactFlash connector 98. The memory device 99 expands the analyzer's ability to store captured vibration and noise data. The memory device 99 can store up to 146 captured events, although memory devices with larger or smaller storage capabilities can also be used.

The microprocessor subsystem 82 also provides an RS232 interface via a conventional universal asynchronous receiver transmitter (UART) chip 100 and an RS232 transceiver 102 that communicate with peripheral devices through an RS232 connector 101 (shown in FIG. 3). The UART chip 100 is capable of operating at all standard RS232 baud rates up to 115.2 (Kbps). It contains a FIFO register, which allows maximum communication speeds without putting an excessive load on the processor.

The microprocessor subsystem 82 also includes a digital signal processor (DSP) 101 which conducts a Fourier transform of the signals from the accelerometers or microphones and generates a frequency spectrum. Many different DSPs can be used with a suitable DSP being the ADSP 2181. In other embodiments of a microprocessor subsystem 82 the Fourier transform can be conducted by the system software, although Fourier transforms conducted in DSPs are generally faster. A clock and calendar circuit 103 is included to generate accurate date and time information that can be used in the noise and vibration analysis. A battery cell 97 is also included to provide back-up power to the clock and calendar circuit 103 and RAM 96 in the event that power from the power subsystem 90 (shown in FIG. 3) is interrupted.

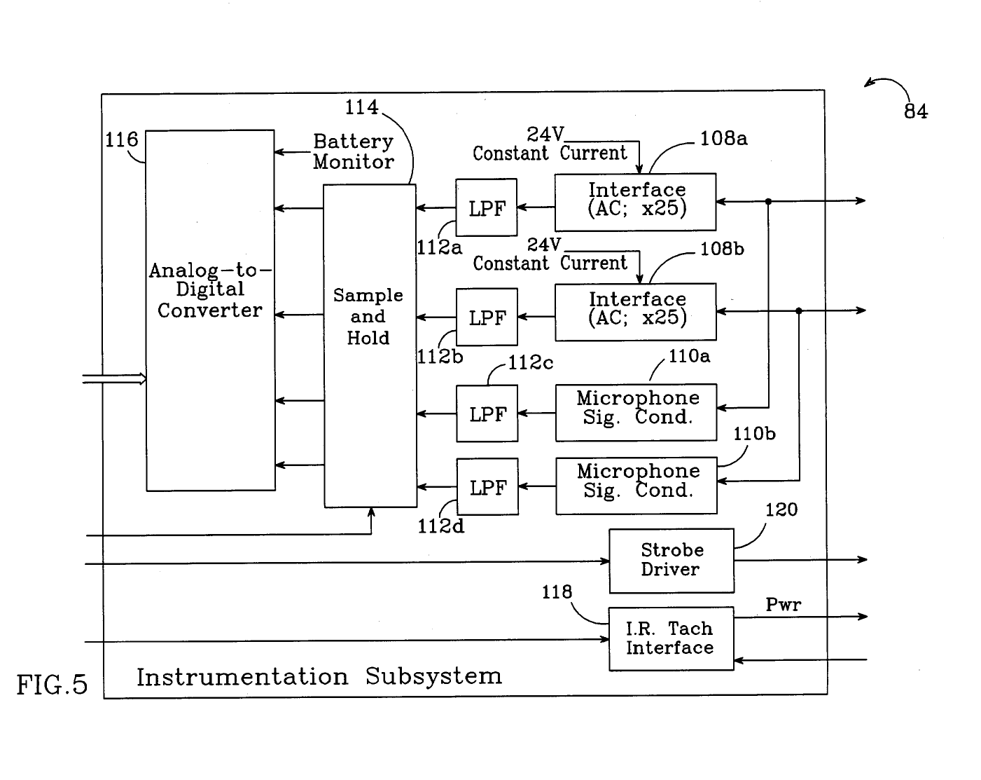

FIG. 5 shows the instrumentation subsystem 84 in more detail. It generally consists of signal conditioning circuitry for the sensors, sampling circuitry, and driver circuitry for the photo-tachometer and timing light- strobe signal. The analyzer 80 has two sensor inputs 104, 106 (shown in FIG. 3), each of which can support one accelerometer or one microphone input. Two accelerometer conditioning circuits 108a, 108b are included in the instrument subsystem 84 to support one or two accelerometers that could be connected to the sensor inputs 104, 106. Two microphone conditioning circuits 110a, 110b are included to support the microphones that could be connected to the sensor inputs 104, 106. The conditioning circuits can operate when one microphone and one accelerometer are connected, with only one of the accelerating conditioning circuits 108a, 108b and one of the microphone conditioning circuit 110a, 110b operating.

Hardware low pass filters 112a-d are included at the outputs of the conditioning circuits 108a, 108b, 110a and 110b, that filter out signals above the maximum frequency bands of interest for the analyzer. Filter 112a and 112b filter out signals above 1000 Hz (accelerometers) and filters 112c and 112d filter out signals above 8 KHz (microphones). For analysis in lower frequency bands, digital filters are implemented in software to lower the cut-off frequency of the low pass filters.

The instrumentation subsystem can also include a sample and hold circuit 114 at the output of the low pass filters 112a-d, which holds the outputs of the filters long enough to allow for a full analog to digital conversion of the signals at the outputs. An eight-channel, bi-polar analog-to-digital converter (ADC) 116 converts the signal from the sample and hold circuit 114 to digital representation of the signals. Many different ADCs can be used with the ADC 116 preferably having a 12-bit (11 bits +sign) resolution and is capable of sampling the input signals at rates of up to 500 Ksamples/second for a single channel. If two input channels are being processed simultaneously (e.g. two accelerometers), the ADC 116 can sample both channels at a rate of up to 50 Ksamples/second. The A/D channels that are not used for sampling the sensor signals can be used for monitoring other analyzer voltages for support of battery charging and self-test.

The instrumentation subsystem 84 also contains a photo-tachometer interface circuit 118, which drives a photo-tachometer 32 (shown in FIG. 1). The photo-tachometer 32 produces a pulsed signal to the microprocessor subsystem 82 that is used to make precise measurements of the speed and phase of a rotating object. The output of the interface circuit 118 is connected to the photo-tachometer connector 119 (shown in FIG. 3) and provides power to the photo-tachometer. The interface circuit 118 also receives signals from the photo-tachometer through the connector 119. The interface circuit 118 is primarily used for driveshaft balancing, but it can also be used to analyze vibration based on other rotating components.

The instrumentation subsystem also includes a strobe light circuit 120 for driving a timing light 32 (shown in FIG. 1), with the output of the circuit 120 connected to a strobe output 121 (shown in FIG. 3). The circuit 120 provides a signal under software and microcontroller control, in the form of a sequence of current pulses. This allows the signal to be synchronized to the frequency of any potential vibration source.

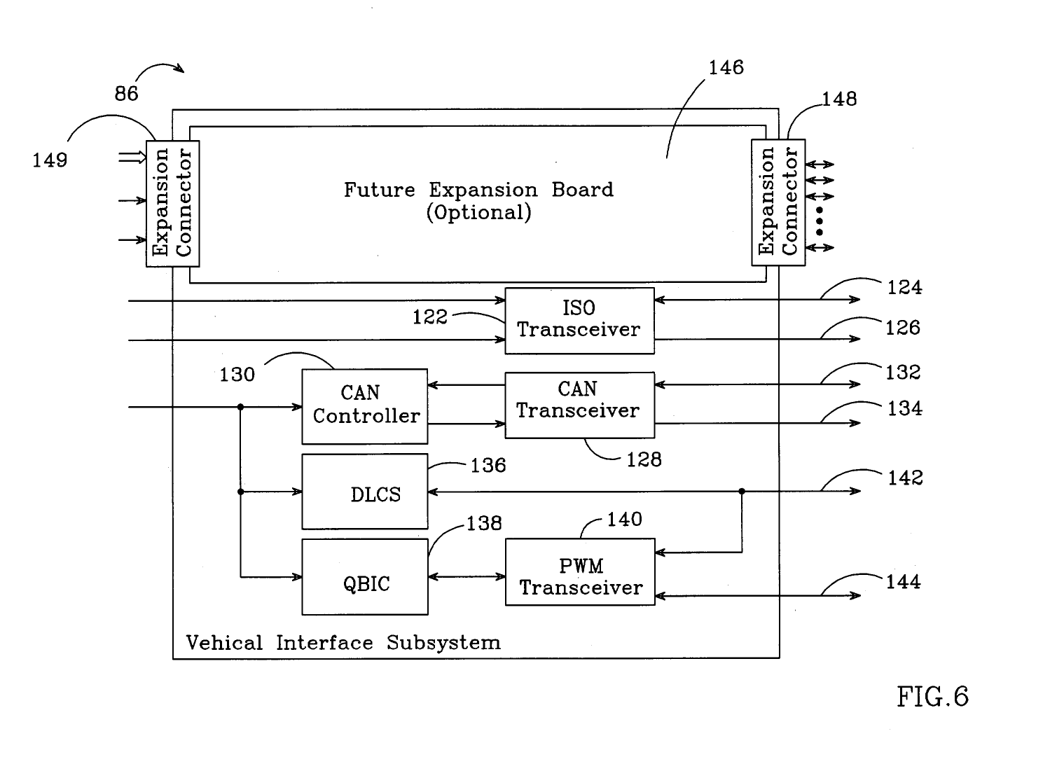

FIG. 6 shows the vehicle interface subsystem 86, which primarily provides the capability of communicating to the vehicle's engine controller and/or transmission controller 64, 65 (shown in FIG. 2) through a diagnostic link connector (DLC) 123 (shown in FIG. 3) for the purpose of obtaining real-time readings of the vehicle's speed, engine RPM and driveshaft RPM. For some vehicles, the vehicle interface subsystem reads calibration information from the vehicle controllers such as vehicle identification number (VIN), tire size and axle ratio. The hardware and software of the analyzer 80 supports all of the currently defined OBD II protocols as well as some future OBD II protocols, allowing it to communicate with any 1996 or later vehicle. A transceiver 122 is included to support International Standards Organization (ISO) 9141-2 communication on an ISO K-line signal line (bi-directional) 124 and an ISO L-line signal line (unidirectional) 126. A controller area network (CAN) transceiver 128 and CAN controller 130 are included to support communication over the CAN+ and CAN− signal lines 132, 134. A data link controller serial (DLCS) 136, a queued bus interface controller (QBIC) 138 and a 41.6K Pulse Width Modulated (PWM) Transceiver 140 are included to support 10.4K VPW J1850 and 41.6K PWM J1850 communication over J1850+ connector pin 142 and J1850-connector pin 144.

The vehicle interface subsystem 86 also contains provisions for an expansion board 146 and connectors 148, 149 for expanding the protocol support. In some cases, expansion can be accomplished simply by a field upgrade of the software, such as the addition of manufacturer specific variations of the OBD II protocols (e.g. SAE J2190). In other cases, expansion to new protocols requires additional hardware. The expansion connector 149 interfaces to the processor's buses and unused pins from the DLC connector 123 are routed to the expansion connector 148 allowing a hardware expansion board to be field installed.

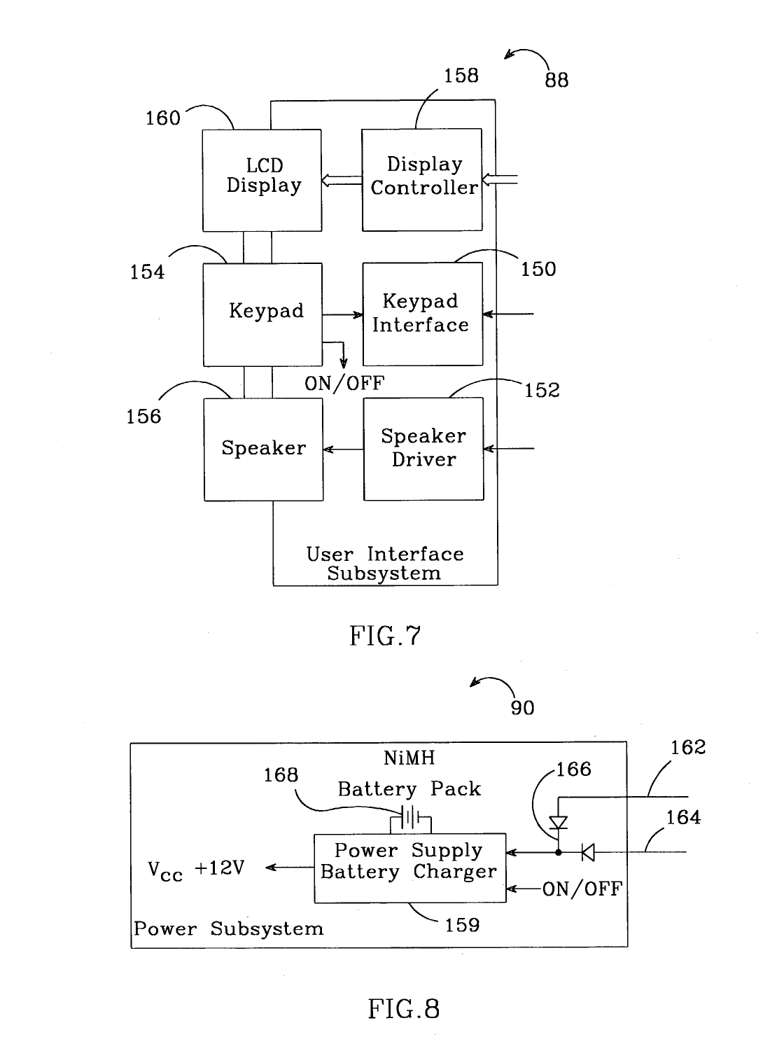

FIG. 7 shows the user interface subsystem 88, which includes a keyboard interface 150 that provides the interface between the keyboard 154 and the microcontroller 92 (shown in FIG. 4). The keypad 154 contains 22 membrane keys, as described above in FIG. 1, each of which can be pressed alone or simultaneously with another key to modify its function. A speaker driver 152 is included that drives a speaker 156 with a signal from the microcontroller 92. The speaker 156 provides an audio alert to signal a particular analyzer condition, such as a full buffer. A display controller 158 is coupled to the microcontroller bus and controls an LCD display 160 in response to commands it receives from the microcontroller 92. The LCD display is preferably a quarter-VGA (320×240 pixels) LCD display with a 4.7″ diagonal viewing area and a cool cathode fluorescent lamp (CCFL) backlight that provides good readability under all lighting conditions. The display 160 provides full graphic capability allowing waveforms to be plotted as well as numerous fonts.

FIG. 8 shows the power subsystem 90 in more detail. Under normal operation, a voltage is supplied to the power supply 159 from the vehicle under test, through the battery voltage pin 162 of the DLC connector 123. Power can also be supplied from an alternate source via a standard power jack 164 on the analyzer 80. This allows the analyzer 80 to be powered from the cigarette lighter in vehicles that do not have a DLC connector 123, or from an AC/DC Adapter for benchtop operation (e.g. for upload of data to PC). Diode protection 166 is provided to eliminate problems if two power sources are connected simultaneously. The analyzer 80 also contains an internal battery pack 168 for operation when the power supply is not connected to an external power source. The battery pack 168 is charged whenever the NVH analyzer is operated from an external power source.

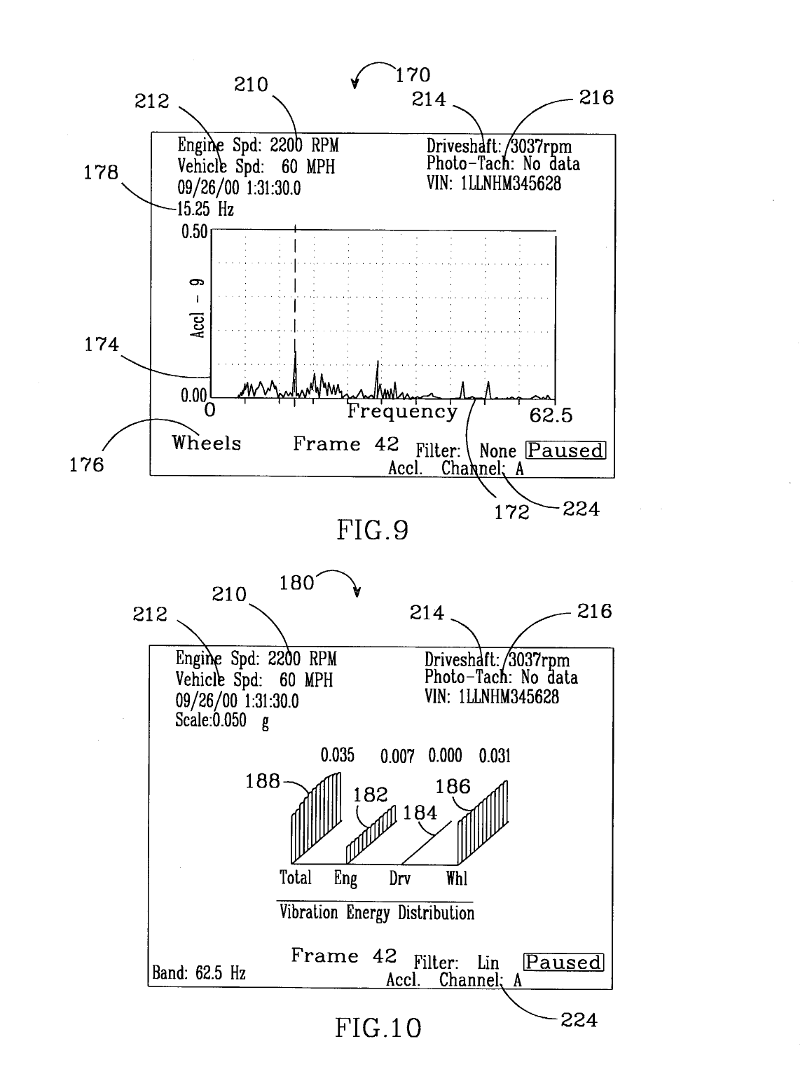

In operation, the analyzer 80 can display test data at its LCD 160 in many different ways to display both real time and stored data, with the preferred LCD display 160 being updated at a minimum rate of 2 updates/second. Four different LCD displays according to the present invention are shown in FIGS. 9-12, although many other displays according to the invention can be displayed on the LCD.

FIG. 9 shows a two-dimensional (2-D) frequency spectrum display 170 according to the present invention that displays real time spectral vibration or noise data. It displays a real time 2-D frequency spectrum of the vibration or noise data as amplitude versus frequency for a specified source of vibrations or noise (e.g. wheels).

The display 170 shows a 62.5 Hz frequency spectrum along the horizontal scale 172 and the amplitude of these frequencies along the vertical scale 174. Different frequency spectrums can be used for the horizontal scale including 125 Hz, 250 Hz, 500 Hz and 1000 Hz for viewing either the real time vibration data (accelerometers) or noise data (microphones). Addition frequency spectrums of 2000 Hz, 4000 Hz and 8000 Hz are also available for viewing noise data. A vibration/nois component identifier 176 is shown for the particular vehicle component being tested, in this case the wheels, and different displays can be shown for the vehicle's engine or driveline. A moveable cursor 178 identifies the magnitude and frequency of the vibration that is present at the current cursor position. In this case the cursor 178 is at the 15.25 Hz frequency, which has a magnitude of 0.025.

FIG. 10 shows a three-dimensional (3-D) barchart display 180 according to the present invention that displays the amount of vibration energy associated with each vibrations source in a bar chart versus time format. The vibration or noise data are displayed in bars that reflect the engine 182, driveline 184, wheel 186, and total 188 energy sampled. Eleven sequential time frames of this data are displayed for analysis and comparison, with the most recent time cycle displayed at the bottom of the barchart display. More or fewer time frames can be displayed and different vibration sources can be displayed.

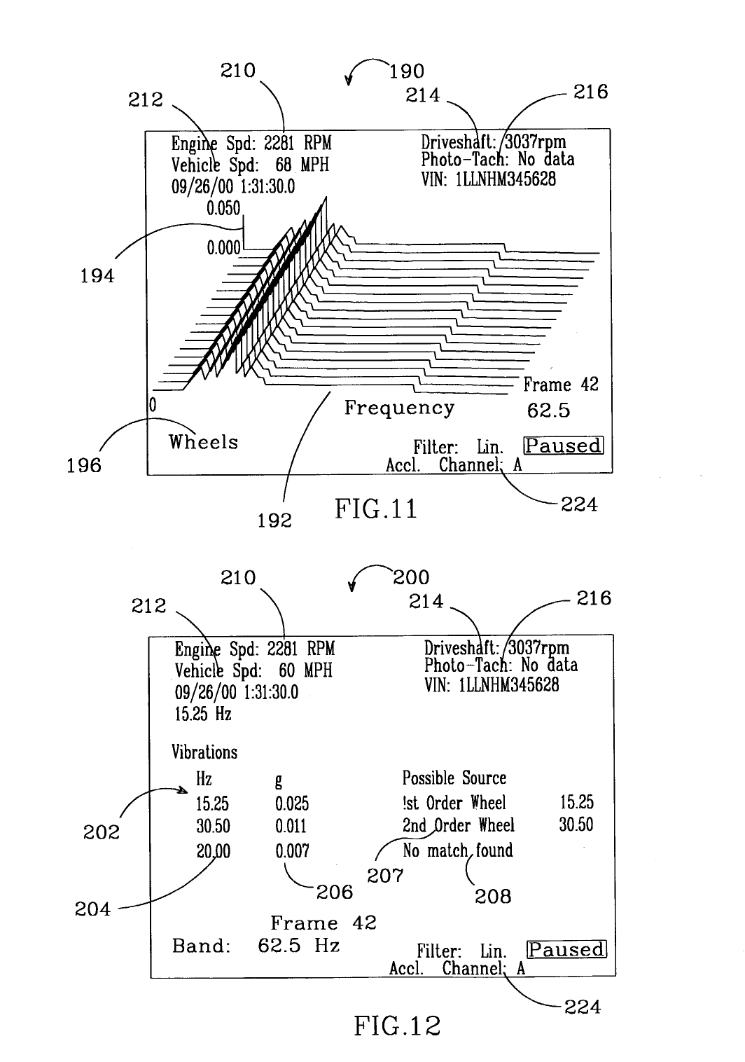

FIG. 11 shows a three-dimensional (3-D) waterfall display 190 according to the present invention that displays a 3-D version of the amplitude verses frequency display 170 shown in FIG. 9. Instead of a 2-D display, the display 190 includes multiple sequential time frames of vibration or noise data in a 3-D raster format. Different number of time frames can be displayed, with the display 190 having twenty one (21) sequential time frames. The most recent cycle is displayed at the bottom of the raster display. Just as in display 170 in FIG. 9, frequency bands of 62.5 Hz, 125 Hz, 250 Hz, 500 Hz and 1000 Hz are available for the horizontal scale 192, for viewing real time spectral vibration data and noise data. Additional frequency bands of 2000 Hz, 4000 Hz and 8000 are used for noise data. The vertical scale 194 is for the amplitude of the frequency. A vibration component identifier 196 identifies the component being tested, in this case the wheels.

FIG. 12 shows a principal component display 200 according to the present invention that includes a list 202 of the largest peaks in a particular frequency spectrum along with their frequency 204 and amplitude 206. In the embodiment shown, up to six different frequencies can be displayed, although other numbers of frequencies can be displayed. The analyzer also compares the frequencies of these components with the characteristic frequencies associated with the vehicle's rotating components (e.g. wheels). If a match is found, the display 200 shows the probable source 207 of the vibration signal (e.g. 2^{nd} Order Wheel). If a frequency does not match one of the vehicle's principal components, a “No match found” message 208 is displayed.

The determination by the analyzer of whether or not a particular vibration or noise frequency matches one or more of the vehicle's principal components is partially controlled by the order cut parameter. This is a user-specified parameter that defines the acceptable frequency error for a match. For each of the vehicle's principal components, the analyzer displays a prioritized list of possible causes for the vibration (e.g. excessive tire or wheel runout).

Each of the displays in FIGS. 9-12 also show data related to engine rotational speed 210, vehicle speed 212, driveshaft speed 214, and photo-tachometer (when used) 216. Each also includes the date 218, time 220, and vehicle identification number 222. A sensor indentifier 224 is also included to show the type of sensor, in this case accelerometer, and which of the two input channels is receiving the sensor date, in this case channel A.

The analyzer keyboard (shown in FIG. 1) contains a RUN/PAUSE key and when the analyzer is in the RUN mode, data is sampled from the sensors and data is being read from the vehicle. This data is saved in a circular buffer in RAM memory, with the buffer being capable of saving up to 30 seconds of data for two sensors. Pressing the RUN/PAUSE key while the analyzer is in the RUN mode causes the analyzer to change to the PAUSE mode. In the PAUSE mode, the data from the previous 30 seconds of testing can be analyzed and displayed in any of the four displays shown in FIGS. 9-12. The vibration/noise data is saved in the time domain allowing the replay of the spectral data to be performed for any frequency band. During the replay, the user can also change sensors, amplitude scales, system identifiers (engine, driveshaft, wheels) and filter mode. The SAVE key can be pressed to copy the captured data to the internal flash memory 94 or to the CompactFlash memory device 99 (both shown in FIG. 5). The NVH can save 24 events in the Flash memory 95 and 122 additional events in the 32 Mbyte CompactFlash device 99.

The software for the analyzer 10 is divided into the boot software and application software. The boot software is programmed at the factory and is considered a permanent part of the analyzer 10. It is programmed into a hardware-protected segment of the Flash EEPROM 94 and requires a special programming fixture for update. The boot software provides all of the functions needed to support reprogramming of the remaining segments of the Flash EEPROM 94. One such routine is power-on reset, which includes the logic necessary to initialize the hardware after a power-on reset. Another is the Real-Time operating system (RTOS) kernel, with is the software necessary to control the analyzer in the real-time environment of data acquisition, signal processing and user interface. Others are the communication routines, which include the software necessary to communicate with a PC via RS232 and to download blocks of data for programming the analyzer's remaining memory. Still others are the flash memory routines, which include the software necessary to read, erase and write blocks of Flash EEPROM memory.

The application software performs all the application specific functions of the analyzer. It can be field upgraded, via an RS232 download from a PC, as new features and functions are added to the software. Some of the functions performed by the application software in different embodiments of the invention include: controlling the moding of the analyzer circuitry; controlling the sampling process; performing a Fast Fourier Transform (FFT) algorithm to convert data to the frequency domain; controlling communication with the vehicle's engine or transmission controller; correlating the vibration or noise frequencies with the characteristic frequencies for various vibration or noise sources; processing of all user inputs; outputting data to the LCD display, and providing an RS232 interface to other system components (e.g. printer or PC).

The application software also provides the user interface, I/0 and computation to perform single and dual plane driveshaft balancing, and provides an output to drive a strobe light at a frequency that is either manually controlled or controlled relative to engine or driveshaft RPM.

In operation the analyzer 80 provides the user interfaces to the LCD Display 160 and speaker 156. The analyzer also conditions the input signals from the sensors attached to the sensor A and sensor B inputs 104, 106, samples these signals and converts them to the frequency domain. At the same time analyzer 80 communicates with the vehicle's engine and transmission controllers over the DLC connector using generic OBD II messaging and manufacturer-specific messaging, to obtain information to support testing. Calibration information, including vehicle identification number (VIN), Axle Ratio, and Tire Size, is available from the engine controller on some vehicles and can also be communicated to the analyzer over the DLC connector. For vehicles that do not support these parameters, the analyzer prompts the user to input them manually. The analyzer 80 contains a database that is used to decode the VIN number to determine the body, engine and drive configuration.

The analyzer 80 also reads operational information from the vehicle's engine and transmission controllers including engine RPM, vehicle speed and transmission output shaft speed. This data is used by the analyzer to compute the characteristic frequencies associated with various noise or vibration sources. It then compares these frequencies with those computed from the sensors in order to assist with the isolation of the source of the vibration or noise.

As described above, a strobe output 120 is provided that can be used to drive a timing light 38 (shown in FIG. 1). The analyzer's software synchronizes flashes of the timing light to a user-selected frequency or to the frequency of a user selected vibration source. This provides the service technician with a visual mechanism for isolating the source of a vibration. The flashes can also be synchronized to harmonics of the engine or driveshaft rotations as reported by the engine or transmission controller.

As also described above, the analyzer 80 (shown in FIG. 3) provides new ways of displaying vibration-related data. On its LCD display 160 it graphically displays frequency and amplitude of vibration or noise energy. It displays probable cause diagnosis for vibrations caused by the engine, driveline, or tires/wheels and is not limited to display of only the three highest vibrations. It integrates frequency data calculated from the sensors with characteristic frequencies of vibrations of on-board components. These frequencies are calculated from real-time vehicle data read from the engine or transmission controller using any of a wide range of serial data, including the OBD II protocols.

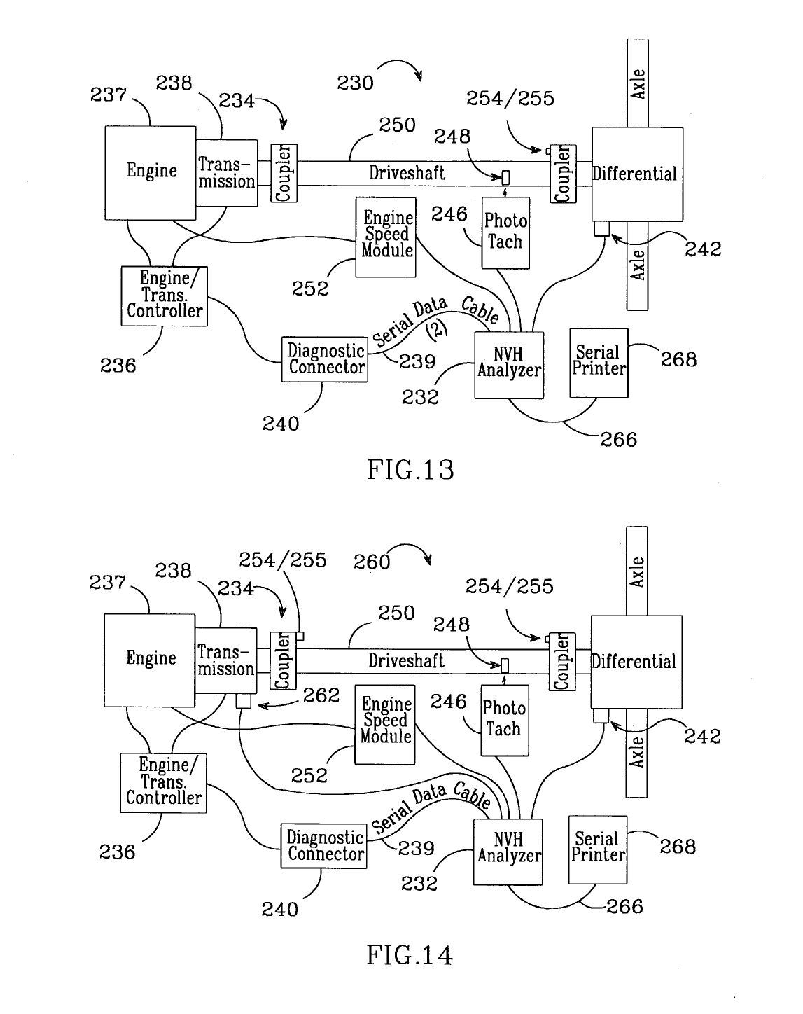

One of the functions performed by the analyzer is dynamic on-vehicle driveshaft balancing, both single-plane and dual-plane. FIG. 13 shows a block diagram of a system 230 for single-plane driveshaft balancing according to the present invention, showing the interconnections between the analyzer 232 and a vehicle 234. The analyzer 232 controls the operation of the balancing analysis and provides the user interface. In the vehicle 234, an engine/transmission controller 236 is connected to and controls the engine 237 and the transmission 238. The analyzer 232 is connected to the engine/transmission controller 236 over a serial data cable 239, through the diagnostic (DLC) connector 240. Through this interface the analyzer 232 reads engine and driveshaft data from the vehicle's engine/transmission controller 236. The serial data cable 239 also provides power to the analyzer 232.

For single-plane balancing, one accelerometer 242 is attached to the axle differential 244 of a driveshaft 250 to measure the amplitude and phase of the vibrations due to driveshaft rotation. The analyzer's photo-tachometer 246 is used to measure the driveshaft RPM and to provide a reference for the phase measurements of the accelerometer's vibration signals. Reflective tape 248 is attached to the driveshaft 250 and as the driveshaft 250 rotates, the light beam emitted from the photo-tachometer 246 reflects off of the reflective tape 248. The reflection generates a pulse at the photo-tachometer 246 for every revolution that is transmitted to and measured by the analyzer 232. The analyzer 232 uses the pulses to compute the driveshaft RPM and this RPM is validated by comparing it to the driveshaft RPM reported by the engine/transmission controller 236 via the serial data cable 239. The time for each pulse is also saved for use in vibration phase calculations.

During the balancing tests, the driveshaft 250 is run at a balancing speed specified by the test operator or by the driveshaft manufacturer. For some vehicle models, the analyzer 232 can control the engine RPM via an engine speed module 252, which adjusts the RPM by controlling the signal that is output to the engine's idle speed control (ISC) solenoid (not shown). The ISC solenoid is normally controlled by the engine/transmission controller 236, but for driveshaft balancing, it can be controlled by the analyzer 232. With the analyzer 232 controlling the engine RPM and monitoring the driveshaft RPM, it performs closed-loop control of the driveshaft RPM in order to maintain the driveshaft rotation at a constant rate equal to the specified driveshaft balancing RPM.

The analyzer 232, samples and filters the accelerometer 242 signals to isolate the fundamental of the vibration frequency (the frequency of revolution of the driveshaft 250). The amplitudes of the filtered vibration signals are then measured, as are the phase angles between the photo-tachometer 246 reference and the peaks of the vibration signals. The center frequency of a bandpass filter is dynamically adjusted so that the filter matches the current value of the driveshaft RPM.

For the single-plane driveshaft balancing procedure, this process is repeated three times with the driveshaft run at the same speed, and the amplitudes of the filtered vibration signals are measured along with the phase angles. The first balancing procedure determines a baseline test with the driveshaft 250 unmodified. The second procedure is conducted with a known “test weight” 254 added to the driveshaft 250. Based on the analysis of the initial baseline measurements and of the effects of adding a test weight 254, the analyzer 232 computes the size and position of a weight that is required to counter balance any vibrations that were present at the start of the test. The preferred location for mounting a counterbalance weight is to near the differential 242. A third balancing procedure is conducted after a repair balance weight 255 has been added, to verify the repair.

FIG. 14 shows a block diagram of a system 260 for dual-plane balancing according to the present invention. Many of the same devices and interconnects that are used in the system 230 of FIG. 13 are used in the system 260 and for these devices and interconnects the same reference numerals are used and they will not be described again herein. For a dual-plane balance system two accelerometers are used, one mounted on fixed surfaces at each end of the driveshaft. The first accelerometer 242 is attached to the differential as in the system 230 of FIG. 13. A second accelerometer 262 is attached to the transmission and like the first accelerometer 242, it provides a sensor input to the analyzer 232.

The dual-plane driveshaft balancing procedure is an extension of the single-plane case and instead of three balancing procedures, it includes four. The first balancing procedure determines a baseline test with the driveshaft 250 unmodified. The second procedure is conducted with a known “test weight” 254 added to the coupler at front of the driveshaft 250. A third balancing procedure is conducted with the test weight 254 from front shifted to the coupler at the rear of the driveshaft 250. At the completion of the procedures performed with the test weight 254 attached to the driveshaft 250, the analyzer 232 computes the amount of imbalance that was present in the driveshaft 250 at the beginning of the test. If that imbalance level is below a specified limit, then the driveshaft 250 is considered balanced and no further testing is required. If the calculated imbalance is above this limit, the analyzer 232 computes the size and position of front and rear counterbalance weights 255 that are required to counterbalance any vibrations that were present at the start of the test. The weights are preferably mounted to the driveshaft near the front and the rear of the driveshaft 250. A fourth balancing procedure is conducted after a repair balance weight 255 has been added, to verify the repair.

Different methods can used for attaching the balancing weight 255 to the driveshaft 250 such as attaching it directly to the driveshaft 250 or attaching it to the coupling flange that connects the driveshaft to the differential (or transmission). The weight 255 can be attached to the driveshaft using bands, hose clamps or spot-welding.

For vehicles that have an appropriately designed coupling flange to connect the driveshaft to the differential, this coupler can be used for both attaching the test weight 254, and for the permanent installation of the balancing weight 255. The balancing weight 255 can be some combination of bolts, nuts and washers. In one case, referred to as nut balancing, the test weight 254 is a nut of known weight installed on a specified coupling bolt. As part of the test, the balancing solution is computed to direct the operator to install a balancing weight 255 that is a combination of nuts on specified bolts. This speeds up the balancing procedure and minimizes the likelihood of errors resulting from improperly installed balancing weights.

Both the single-plane and dual plane driveshaft balancing systems provide support for a hard-copy printout of test results. An RS232 interface 266 is included to communicate with serial printer 268 that is provided to generate documentation for the driveshaft balance procedure.

Although the present invention has been described in considerable detail with reference to certain preferred configurations thereof, other versions are possible. The analyzer can support other inputs and outputs and can display its captured data in many different ways. Other hardware and software components could also be used in other analyzer embodiments according to the present invention and the hardware components could be used in different ways. The analyzer can also be used to analyze noise or vibration in vehicle components beyond those described above and in systems other than vehicles Therefore, the spirit and scope of the present invention should not be limited to the preferred versions of the invention described above.

We claim:

1. A vehicle noise, vibration and harshness analyzer, comprising:
at least one sensor, each of which senses a vibration or noise and generates a signal at a frequency related to the vibration or noise;
a communication link with a vehicle, said link capable of transmitting data regarding the vehicle;
a microprocessor system that receives said signals generated by said at least one sensor and receives said vehicle data over said communication link, said microprocessor conducting an analysis of said received sensor signals and said vehicle data to identify a vehicle component that is likely causing a vibration or noise, and to identify the possible problems with said identified vehicle component; and
a user interface including a display, said microprocessor system causing said display to list said likely vehicle components causing said vibration or noise and said possible problems with said components.

2. The analyzer of claim 1, further comprising a photo-tachometer, wherein said microprocessor provides power to and receives a signal from photo-tachometer to assist in balancing a driveshaft.

3. The analyzer of claim 1, wherein said microprocessor system generates a strobe light output to power a strobe light used to determine the cause of a vibration.

4. The analyzer of claim 1, wherein said vehicle data includes data from the group of data consisting of engine revolutions per minute (RPM), vehicle speed, and transmission output shaft speed.

5. The analyzer of claim 1, wherein said vehicle data is calibration data from the group of data consisting of vehicle identification number (VIN), tire size, and axle ratio.

6. The analyzer of claim 1, wherein said microprocessor system causes said display to display a graphical representation of said frequencies signals from said at least one sensor.

7. The analyzer of claim 1, wherein said microprocessor system causes said display to display a two-dimensional frequency spectrum display for real time spectral vibration or noise data.

8. The analyzer of claim 1, wherein said microprocessor system causes said display to display a three-dimensional barchart display that shows the amount of energy associated with each vibration source.

9. The analyzer of claim 1, wherein said microprocessor system causes said display to display a three dimensional waterfall display of a frequency spectrum for real time vibration or noise data and past frequency spectrums for vibration or noise data.

10. The analyzer of claim 1, wherein said microprocessor system is capable of storing a series of time sequential signals from said sensors.

11. The analyzer of claim 10, wherein said microprocessor system causes said display to display information calculated from said stored series of time sequential signals.

12. The analyzer of claim 2, further comprising reflective tape and weights, said reflective tape placed on the vehicles rotating driveshaft and said photo-tachometer illuminating said driveshaft and generating a pulse as said reflective tape passes, said weights being attached to said driveshaft and said microprocessor system using said pulses and vehicle data to determine if said driveshaft is balanced.

13. The analyzer of claim 12, wherein said microprocessor system determines that said driveshaft is not balanced, said microprocessor system determining the location for a weight on a driveshaft to counter said imbalance.

14. The analyzer of claim 1, wherein said at least one sensor comprises a plurality of sensors from the group consisting of accelerometers, microphones, or a combination thereof.

15. A vehicle noise, vibration and harshness analyzer, comprising:
an instrumentation subsystem for receiving signals from a plurality of sensors, each of said signals relating to a vehicle noise or vibration;
a vehicle interface subsystem for communicating with vehicle subsystems and receiving data regarding the vehicle;
a microprocessor subsystem that receives said sensor signals from said instrumentation subsystem and receives said vehicle data from said vehicle subsystem interface, said microprocessor conducting an analysis of said sensor signals and vehicle data to determine a the vehicle component cause the vibration or noise; and
a user interface subsystem including a display, said microprocessor subsystem causing said display to list said likely vehicle components causing said vibration or noise.

16. The analyzer of claim 15, wherein said microprocessor subsystem determines possible problems with said vehicle components and causes said display to list said possible problems.

17. The analyzer of claim 15, wherein said microprocessor subsystem causes said display to display a graphical representation of said frequencies signals from said at least one of said sensor signals.

18. The analyzer of claim 15, wherein said instrumentation subsystem conducts an analog to digital conversion of said sensor signals, said microprocessor subsystem conducting a Fourier transform on each of said digitally converted sensor signals.

19. The analyzer of claim 18, wherein said microprocessor system contains memory that is capable of storing a series of time sequential digital representation of said sensor signals.

20. The analyzer of claim 19, wherein said microprocessor system causes said display to display information calculated from said stored series of time sequential signals.

21. The analyzer of claim 15, wherein said interface subsystem includes timing light circuitry to generates a strobe light output to power a strobe light used to determine the cause of a vibration.

22. The analyzer of claim 15, wherein said instrumentation subsystem further comprises a photo-tachometer interface circuit that provides power to and receives a signal from a photo-tachometer used by said analyzer to balance driveshafts.

23. The analyzer of claim 22, further comprising reflective tape and weights, said reflective tape placed on rotating mechanism in a vehicle, said photo tachometer illuminating said rotating mechanism, said interface circuit receiving a pulse when said reflective tape passes under said illumination, said microprocessor subsystem receiving said pulses and vehicle data and determining if said driveshaft is balanced.

24. The analyzer of claim 22, wherein said microprocessor subsystem calculates the appropriate counterweight to balance an unbalanced driveshaft.

25. A method for determining if a driveshaft is balanced, comprising:
performing a first balance test on an unmodified driveshaft;
performing a second balance test on said driveshaft with a test weight mounted to the driveshaft; and
analyzing the results of said first and second balance tests to determine if said driveshaft is out of balance.

26. The method of claim 25, further comprising determining the appropriate location and weight of a counterbalance weight to attach to said driveshaft to counter any driveshaft imbalance.

27. The method of claim 25, further comprising attaching a balance weight to said driveshaft to counter any driveshaft imbalance and performing a third balance test to confirm that said driveshaft is balanced.

28. The method of claim 27, wherein said first, second and third balance tests are performed by a noise, vibration and harshness analyzer.

29. A method for determining if a driveshaft is balanced, comprising:
performing a first balance test on an unmodified driveshaft;
performing a second balance test on said driveshaft with a test weight mounted near the front of said driveshaft;
performing a third balance test on said driveshaft with a test weight mounted near the rear of said driveshaft; and
analyzing the results of said first, second and third balance tests to determining if said driveshaft is out of balance.

30. The method of claim 29, further comprising determining the appropriate locations and weights of a counterbalance weights to mount to the front and rear of said driveshaft to counter any driveshaft imbalance.

31. The method of claim 29, further comprising attaching said balance weights to said driveshaft to counter any driveshaft imbalance and performing a fourth balance test to confirm that said driveshaft is balanced.

32. The method of claim 31, wherein said first, second, third and fourth balance tests are performed by a noise, vibration and harshness analyzer.
